(19) United States
(12) Patent Application Publication
(10) Pub. No.: US 2022/0342035 A1
(43) Pub. Date: Oct. 27, 2022

(54) RADAR SYSTEM FOR AN AUTONOMOUS VEHICLE

(71) Applicant: Nuro, Inc., Mountain View, CA (US)

(72) Inventor: Russell Leigh Smith, Mountain View, CA (US)

(21) Appl. No.: 17/673,192

(22) Filed: Feb. 16, 2022

Related U.S. Application Data
(60) Provisional application No. 63/178,659, filed on Apr. 23, 2021.

(51) Int. Cl. G01S 7/03; G01S 7/35; G01S 13/931

(52) U.S. Cl. CPC G01S 7/032; G01S 7/35; G01S 13/931; G01S 2013/0245

(57) ABSTRACT

According to one aspect, a radar system suitable for use in an autonomous vehicle is configured to provide a relatively high resolution in azimuth. The radar system may include multiple antenna blocks which may each include a transmitter and a receiver, and may be provided in an array, e.g., in a horizontal array. Each radar block may define an airgap therein which includes azimuth power dividers, elevation power dividers, vertical power dividers, and open-ended waveguides.

### CROSS REFERENCE TO RELATED APPLICATION

This application claims priority to U.S. Provisional Application No. 63/178,659, filed Apr. 23, 2021, entitled “Radar System for an Autonomous Vehicle,” the entirety of which is incorporated herein by reference.

### TECHNICAL FIELD

The disclosure relates to providing systems for autonomous vehicles. More particularly, the disclosure relates to radar system with an azimuthal resolution that facilitates the operation of autonomous vehicles at increased speeds.

### BACKGROUND

As the use of autonomous vehicles increases, the operation of autonomous vehicles at relatively high speeds is also increasing. Sensors used on autonomous vehicles, e.g., automotive radar sensor systems, generally have limitations which make it difficult for the sensors to operate with the precision needed to enable the autonomous vehicles to operate at relatively high speeds. For example, limitations with the azimuthal resolution of automotive radar sensor systems often makes it difficult for autonomous vehicles to determine object locations with precision up to approximately two hundred meters away.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4A is a block diagram representation of a radar system, e.g., radar system of FIG. 3, in accordance with an embodiment.

FIG. 4B is a block diagram representation of a radar system, e.g., radar system of FIGS. 3 and 4A, with a transmitter (TX) antenna arrangement and a receiver (RX) antenna arrangement in accordance with an embodiment.

FIG. 4C is a block diagram representation of a radar system, e.g., radar system of FIG. 4B, with a radar sensor arrangement which includes frequency modulated continuous wave (FMCW) radar sensors in accordance with an embodiment.

FIG. 5 is a diagrammatic representation of a radar system in accordance with an embodiment.

FIG. 6A is a diagrammatic top view of an autonomous vehicle on which multiple radar systems may be mounted in accordance with an embodiment.

FIG. 6B is a rear perspective view a waveguide assembly that contains a radar antenna arrangement designed to be mounted on an autonomous vehicle, in accordance with an embodiment.

FIG. 6C is a diagram illustrating the waveguide assembly of FIG. 6B mounted on the front of an autonomous vehicle according to an embodiment.

FIG. 6D is a diagram illustrating an autonomous vehicle traveling along a road with a front mounted radar system that can emit a narrow beam at distance to detect objects in azimuth with high resolution, according to an embodiment.

FIG. 7 is a block diagram representation of an antenna arrangement that includes vertically stacked antennas in accordance with an embodiment.

FIG. 8 is a block diagram representation of an antenna arrangement that includes horizontally arrayed antennas in accordance with an embodiment.

FIG. 9A is a diagrammatic representation of an antenna block in accordance with an embodiment.

FIG. 9B is a diagrammatic exploded view representation of an antenna block, e.g., antenna block of FIG. 9A, in accordance with an embodiment.

FIG. 9C is a diagrammatic representation of a plurality of antenna blocks arranged in an array to form a radar antenna arrangement, in accordance with an embodiment.

FIG. 10A is a diagrammatic representation of an airgap that may be defined within an antenna block in accordance with an embodiment.

FIG. 10B is a diagrammatic top view representation of an airgap, e.g., airgap of FIG. 10A, in accordance with an embodiment.

FIG. 10C is a diagrammatic top view representation of a structure of an airgap, e.g., airgap of FIG. 10B, as shown with sections labelled in accordance with an embodiment.

FIG. 10D is a diagrammatic top view representation of a portion of an airgap, e.g., portion of airgap structure of FIG. 10C, which shows components of a transmit antenna or a receive antenna in accordance with an embodiment.

FIG. 11 is a diagrammatic representation of an elevation power divider and open-ended waveguides in accordance with an embodiment.

FIG. 12 is a diagrammatic representation of a serpentine waveguide structure and illustrating its operation in as representative of the operation of the structure shown in FIG. 10D according to an embodiment.

FIG. 13A is a diagram showing a pattern of narrow transmit beams produced by a radar antenna arrangement comprising a plurality of antenna blocks as shown in FIG. 9C, according to an embodiment.

FIG. 13B is a diagram, similar to FIG. 13A, and showing overlay of a transmit beams and receive beams associated with a radar antenna arrangement comprising a plurality of antenna blocks as shown in FIG. 9C, according to an embodiment.

FIG. 13C is a diagram, similar to FIG. 13A, and showing wider transmit beams that would be produced by an antenna arrangement that does not employ the multiple element structure as present herein.

FIG. 14 is a block diagram of a computing device that may be employed to perform various signal processing operations associated with a radar sensor system, according to an embodiment.

FIG. 15 is a flow chart depicting a method for operating a radar system that employs the radar antenna arrangement structures presented herein, according to an embodiment.

### DESCRIPTION OF EXAMPLE EMBODIMENTS

### General Overview

In one embodiment, a radar system suitable for use in an autonomous vehicle is configured to provide a relatively high resolution in azimuth. The radar system may include multiple antenna blocks which may each include a transmitter and a receiver, and may be provided in an array, e.g., in a horizontal array. Each radar block may include azimuth power dividers, elevation power dividers, and vertical power dividers.

### Description

Automotive radar sensor systems used on autonomous vehicles typically do not operate with the precision needed to enable the autonomous vehicles to accurately make determinations relating to other vehicles, in the azimuth, in the same environment as the autonomous vehicles. Limitations with the azimuthal resolution of automotive radar sensor systems often makes it difficult for autonomous vehicles to determine object locations with precision at distance, as for example at a distance of up to approximately two hundred meters (m). Typical automotive radar sensors are less than approximately twenty-five centimeters (cm) in width, with an azimuthal resolution that is substantially limited to approximately one degree. These existing radar systems are designed for passenger vehicles where there is not sufficient space available to mount a radar sensor that is wide enough to increased azimuthal resolution. Using typical automotive radar sensors, difficulty in ascertaining certain situations may arise. The situations encountered by an autonomous vehicle may include, but not limited to, determining the lane in which an oncoming vehicle is driving while attempting to make a turn at an unprotected intersection and/or determining whether distant oncoming vehicles in a two-lane road are in the same lane as the autonomous vehicle.

By providing a radar system which may be used to support the operation of an autonomous vehicle at a relatively high speed, the safety with which the autonomous vehicle may be enhanced. In one embodiment, a radar system provides an increased azimuthal resolution relative to typical automotive radar sensor systems. Such a radar system may have a width of up to approximately one meter, and may be provided either as a single radar block or as an array of multiple radar blocks which may each include a transmitter and a receiver. The embodiments presented herein provide for a better radar system that is competitive in performance with a lidar sensor and a camera sensor. All three (radar, lidar and camera/video) sensors can be on a level playing field so that the sensor data from them can be compared it is easier to fuse the sensor data from these three sensors.

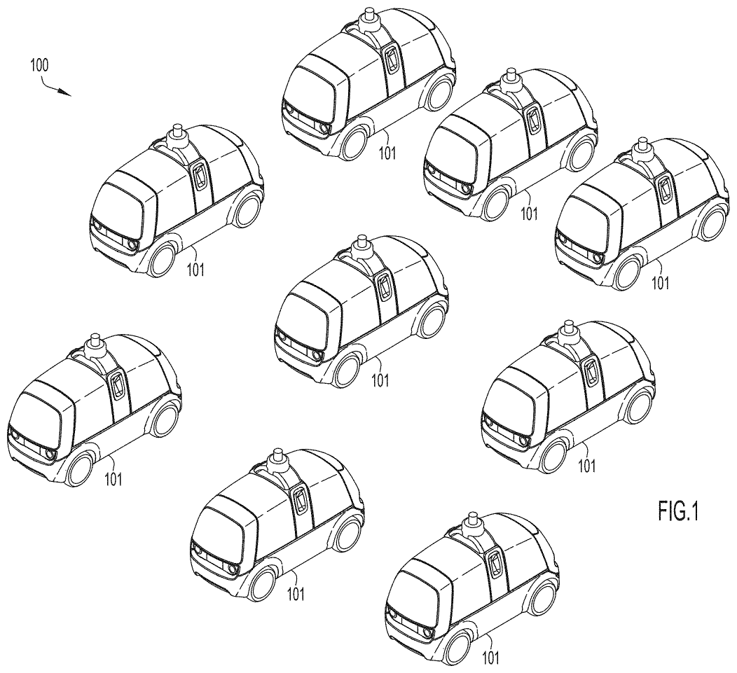

Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

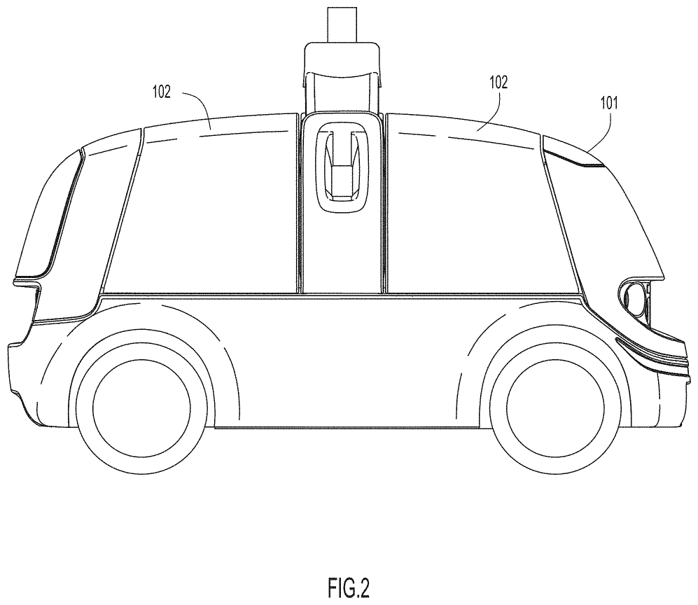

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102 may be assigned to one or more entities, such as one or more customer, retailers, and/or vendors. Compartments 102 are generally arranged to contain cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

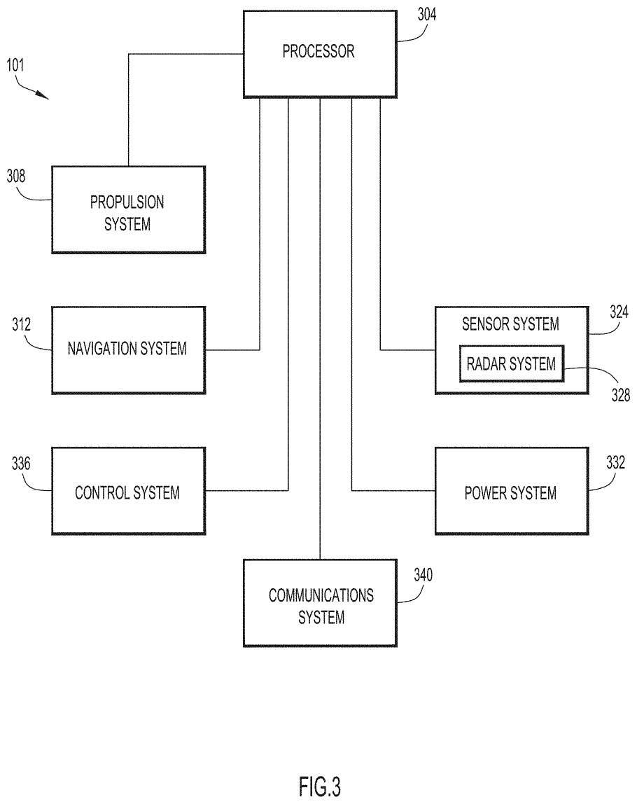

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

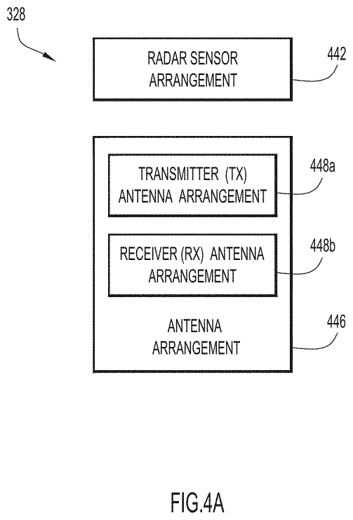

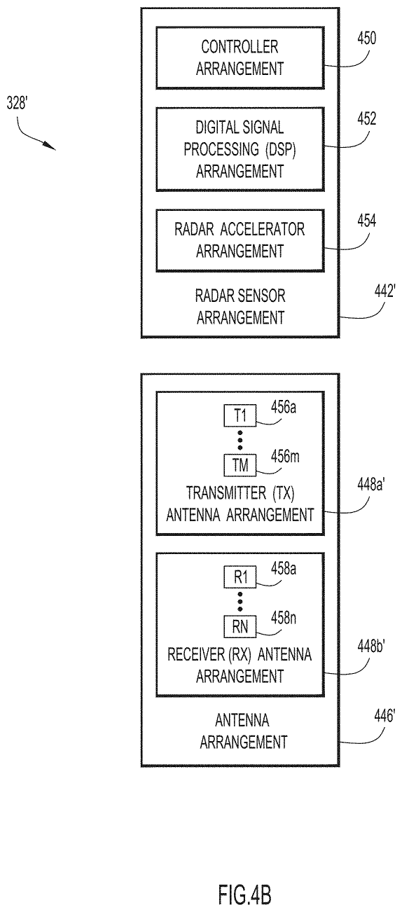

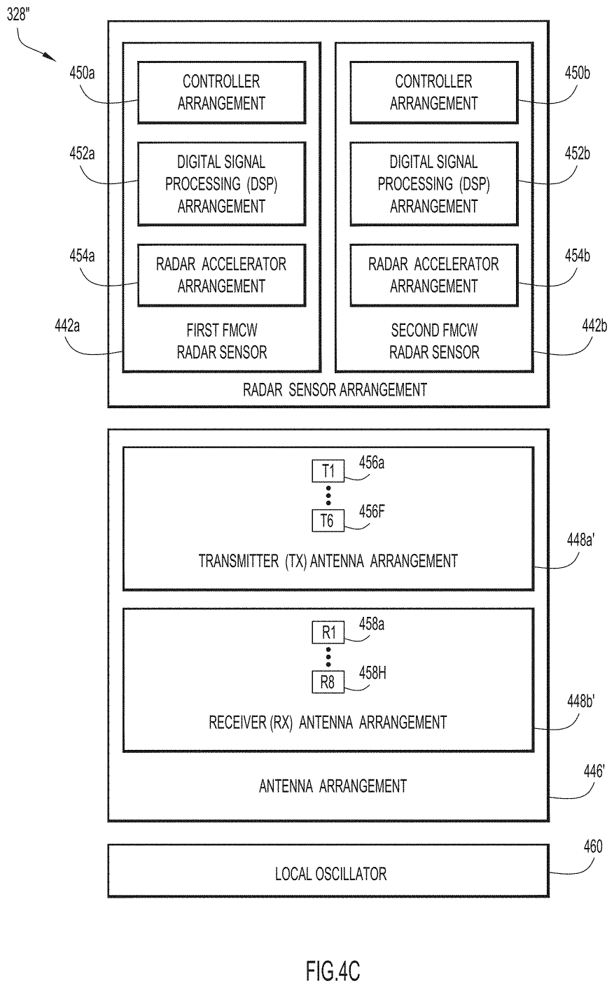

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle 101. In one embodiment, sensor system 324 may include propulsion systems sensors that monitor drive mechanism performance, drive train performance, and/or power system levels. Data collected by sensor system 324 may be used by a perception system associated with navigation system 312 to determine or to otherwise understand an environment around autonomous vehicle 101. In one embodiment, sensor system 324 includes a radar system 328 that has a relatively high azimuthal resolution. Radar system 328 will be discussed below with reference to FIGS. 4A-4C.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not have the capacity to provide sufficient power.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 336 may cooperate with processor 304 to determine where autonomous vehicle 101 may safely travel, and to determine the presence of objects in a vicinity around autonomous vehicle 101 based on data, e.g., results, from sensor system 324. In other words, control system 336 may cooperate with processor 304 to effectively determine what autonomous vehicle 101 may do within its immediate surroundings. Control system 336 in cooperation with processor 304 may essentially control power system 332 and navigation system 312 as part of driving or conveying autonomous vehicle 101. Additionally, control system 336 may cooperate with processor 304 and communications system 340 to provide data to or obtain data from other autonomous vehicles 101, a management server, a global positioning server (GPS), a personal computer, a teleoperations system, a smartphone, or any computing device via the communications system 340. In general, control system 336 may cooperate at least with processor 304, propulsion system 308, navigation system 312, sensor system 324, and power system 332 to allow vehicle 101 to operate autonomously. That is, autonomous vehicle 101 is able to operate autonomously through the use of an autonomy system that effectively includes, at least in part, functionality provided by propulsion system 308, navigation system 312, sensor system 324, power system 332, and control system 336. Components of propulsion system 308, navigation system 312, sensor system 324, power system 332, and control system 336 may effectively form a perception system that may create a model of the environment around autonomous vehicle 101 to facilitate autonomous or semi-autonomous driving.

As will be appreciated by those skilled in the art, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 324 may be processed such that the environment around autonomous vehicle 101 may effectively be perceived.

As will become apparent from the details presented below, the radar system 328 is configured to achieve improved azimuthal resolution, as well as better signal-to-noise ratio, better clutter rejection that can help distinguish objects more easily in azimuth.

Automotive radar systems, operating in the 76-81 GHz band, have radar waves with a physical wavelength of approximately 4 mm, which is reasonably large compared to light waves used by lidar sensors. This means the radar sensor itself needs to be reasonably large to focus a beam. If it is desired to have a particularly well focused beam, e.g., beam width in the range of 0.2 degrees, which is useful for determining which lane another vehicle is in at 200 meters from the source of the beam, and the wavelength is approximately 4 mm, the radar sensor needs to be approximately 1 meter wide, which is fairly large. However, better resolution in azimuth can be achieved with a radar sensor of this approximate size for the vehicle applications described herein.

FIG. 4A is a block diagram representation of radar system 328 of FIG. 3 in accordance with an embodiment. Radar system 328 includes a radar sensor arrangement 442 and an antenna arrangement 446. Antenna arrangement 446 generally includes a transmitter (TX) antenna arrangement 448a and a receiver (RX) antenna arrangement 448b. TX antenna arrangement 448a is configured to transmit or otherwise provide a radio signal or beam while RX antenna arrangement is configured to receive or otherwise detect a reflected radio signal or beam.

With reference to FIG. 4B, one embodiment of radar sensor arrangement will be described of radar system 328′. Within radar system 328′, radar sensor arrangement 442′ includes a controller arrangement 450, a digital signal processing (DSP) arrangement 452, and a radar accelerator arrangement 454. Controller arrangement 450 may generally coordinate the function of radar system 328′, and may include a frequency generator and a timing control unit.

Antenna arrangement 446′ includes TX antenna arrangement 448a′ and RX antenna arrangement 448b′. TX antenna arrangement 448a′ includes one or more transmitters 456a-456F, while RX antenna arrangement 448b′ includes one or more receivers 458a-456H. It should be appreciated that while the number of transmitters 456a-m and the number of receivers 458a-n may be substantially equal, the number of transmitters 456a-m is not limited to being substantially equal to the number of receivers 458a-n.

In one embodiment, radar sensor arrangement 442′ may include one or more frequency modulated continuous wave (FMCW) radar sensors. Referring next to FIG. 4C, the inclusion of FMCW radar sensors in radar sensor arrangement 442′ in a radar system 328″ will be described in accordance with an embodiment. Radar system 328″ includes radar sensor arrangement 442″ which includes a first FMCW radar sensor 442a and a second FMCW radar sensor 442b. First FMCW radar sensor 442a includes a first control arrangement 450a, a first DSP arrangement 452a, and a first radar accelerator arrangement 454a. Second FMCW radar sensor 442b includes a second control arrangement 450b, a second DSP arrangement 452b, and a second radar accelerator arrangement 454b. In the described embodiment, antenna arrangement 446″ is such that TX antenna arrangement 448a′ includes approximately six transmitters 456a-f, while antenna arrangement 448b″ includes approximately eight receivers 456a-h.

Radar system 328″ also includes at least one local oscillator 460. As will be appreciated by those skilled in the art, local oscillator 460 is arranged to change the frequency of signals.

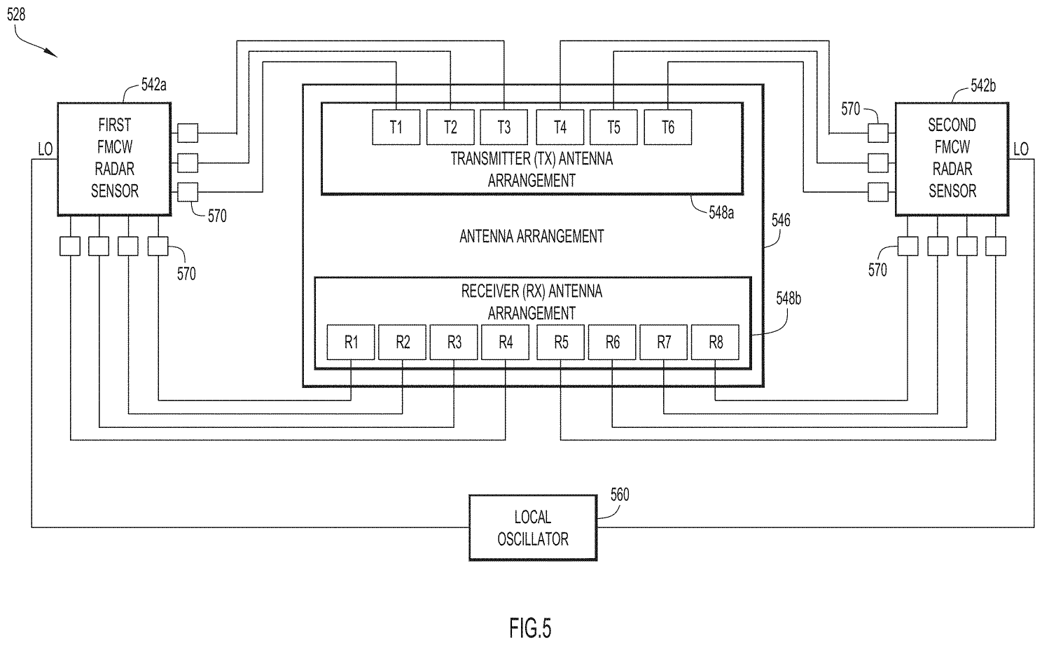

FIG. 5 is a diagrammatic representation of a radar system in accordance with an embodiment. A radar system 528 includes a first FMCW radar sensor 542a, a second FMCW radar sensor 542b, and an antenna arrangement 546. Antenna arrangement 546 includes a TX antenna arrangement 548a and a RX antenna arrangement 548b. Antenna arrangement 546 may be configured as dispersive leaky waveguide multi-beam grating lobe arrays.

As shown, TX antenna arrangement 548a includes approximately six transmitters and RX antenna arrangement 548b includes approximately eight receivers. In one embodiment, TX antenna arrangement 548a and RX antenna arrangement 548b may be substantially interleaved, e.g., horizontally, such that elevation focus may be simplified. TX phase shifters may be used to facilitate the steering of beams. Beams may be steered as a center frequency is changed, e.g., from approximately seventy-six Gigahertz (GHz) to approximately eighty-one GHz. A local oscillator 560 may be used to substantially couple first FMCW radar sensor 542a and second FMCW radar sensor 542b. In this arrangement, the radar system 528 is arranged to operate coherently since the local oscillator is coupled to the first FMCW radar sensor 542a and second FMCW radar sensor 542b. The first FMCW radar sensor 542a and second FMCW radar sensor 542b may be embodied by off-the-shelf radar chips/chipsets or may be specially designed devices. As will be described in more detail below, the transmit antennas and receive antennas may interleaved horizontally to simplify elevation focus.

There are waveguide probe transitions 570 that connect the first FMCW radar sensor 542a and second FMCW radar sensor 542b to the respective transmit antenna arrangement 548a and receive antenna arrangement 548b. The first FMCW radar sensor 542a may be configured to be coupled to a first subset of transmit antennas in the transmit antenna arrangement 548a and to a first subset of receive antennas in the receive antenna arrangement 548b. The first FMCW radar sensor 542a provides a transmit signal to a respective one of the first subset of transmit antennas and processes a receive signal obtained from a respective one of the first subset of receive antennas. Similarly, the second FMCW radar sensor 542b is configured to be coupled to a second subset of transmit antennas in the transmit antenna arrangement 548a and to a second subset of receive antennas in the receive antenna arrangement 548b. The second FMCW radar sensor 542b provides a transmit signal to a respective one of the second subset of transmit antennas and processes a receive signal obtained from a respective one of the second subset of receive antennas.

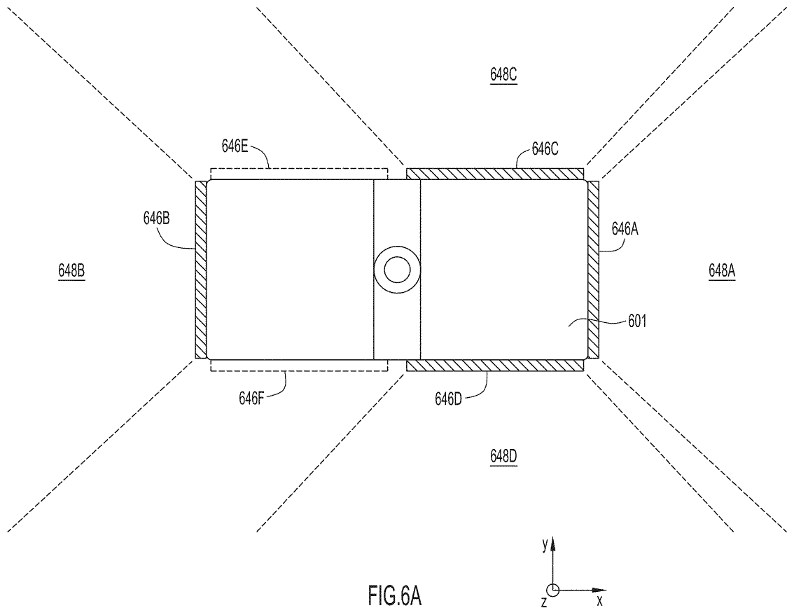

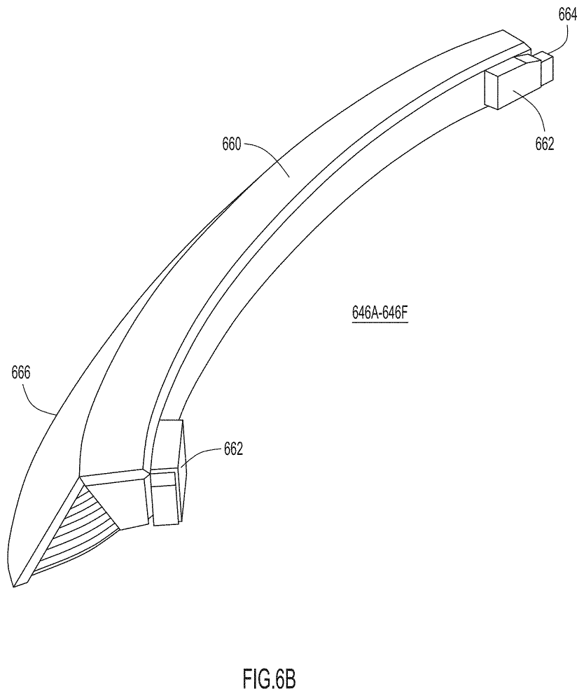

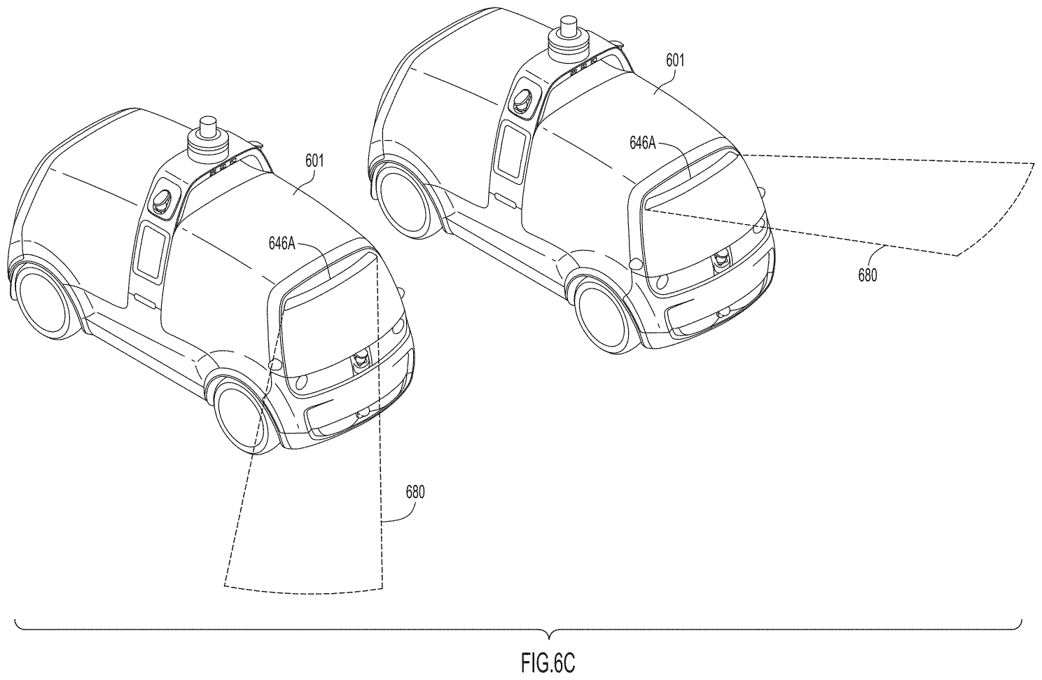

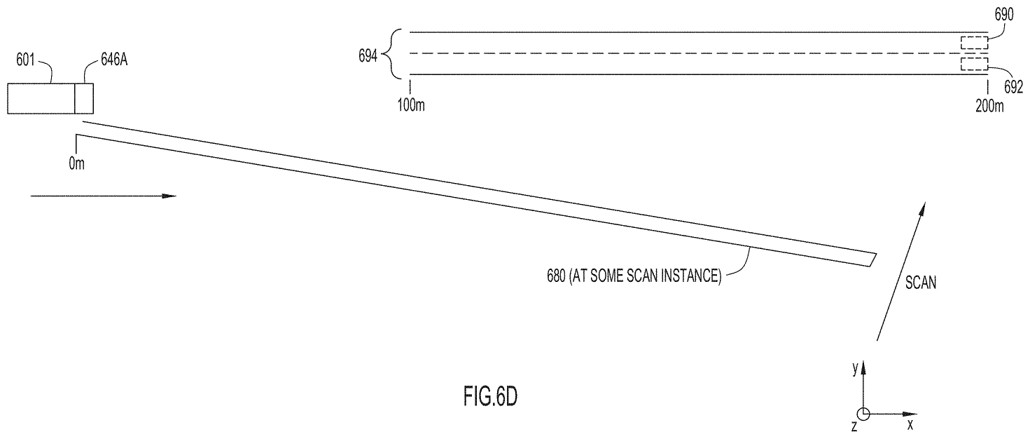

A radar system may be arranged to scan a relatively narrow beam across a horizontal field of view. In one embodiment, a radar system may scan approximately ninety degrees, e.g., in approximately three hundred steps. As such, multiple radar systems may be positioned on an autonomous vehicle such that an approximately three hundred sixty degree field of view may be covered. FIG. 6A is a diagrammatic top view of an autonomous vehicle on which multiple radar systems may be mounted in accordance with an embodiment. An autonomous vehicle 601 may include at least one radar system 646A mounted on a front, a radar system 646B mounted on a back, and radar systems 646C and 646D mounted on the two sides of autonomous vehicle 601. The field of view of each of the radar systems 646A-646D are generally shown at reference numerals 648A, 648B, 648C and 648D, respectively. In one embodiment, optional radar systems 646E and 646F may be mounted on sides of autonomous vehicle 601 to ensure an approximately three hundred sixty degree field of view.

FIG. 6B illustrates an example form factor of one of the radar systems 646A-646F shown in FIG. 6A, and configured to be mounted on an autonomous vehicle. The radar system may be configured in a curved elongated orientation that includes a waveguide assembly 660 in which the transmit antenna arrangement 548a and the receive antenna arrangement 548b are contained. The overall length of the radar system may be approximately one meter, and it may have a height of 5 cm. The FMCW radar sensors 542a and 542b are mounted in pods 662 at the ends of the waveguide assembly 660 and connect to the waveguide assembly 660 via connectors 664 containing the waveguide probe transitions 570. A radome 666 is provided that fits over the waveguide assembly 660. Each radar system 646A-646F may have a 90 degree field of view, in one example embodiment.

FIG. 6C shows a view of radar system 646A mounted on the front of autonomous vehicle 601. The radar system 646A produces a beam 680 that essentially sweeps/scans across its field of view and because the radar system 646A uses a relatively wide transmit antenna/receive antenna arrangement, the beam 680 is relatively straight/narrow in azimuth out at distance from the autonomous vehicle, such as 200 meters, where it is desired to be above to resolve objects in azimuth.

FIG. 6D illustrates an autonomous vehicle 601 traveling along a road with the front mounted radar system 646A operational in a forward path of the autonomous vehicle 601. The radar system 646A emits a radar beam 680 that, due to the specific detailed structure of the transmit antenna arrangement 548a and the receive antenna arrangement 548b, is a “narrow beam,” meaning the beam 680 has substantially the same width in azimuth out away from the autonomous vehicle 601, which allows for better resolution in the azimuth at distance. This is particular useful in distinguishing, for example, oncoming vehicles 690 and 692 in to the autonomous vehicle 601 adjacent lanes 694 of oncoming traffic.

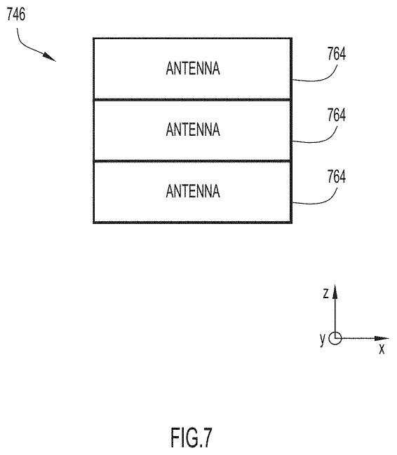

Each radar system may include an antenna arrangement that includes multiple antennas. The multiple antennas may be vertically arrayed or stacked, or the multiple antennas may be horizontally arrayed. FIG. 7 is a block diagram representation of an antenna arrangement that includes vertically stacked antennas in accordance with an embodiment. An antenna arrangement 746 may include multiple antennas 764 that are stacked vertically, or with respect to a z-axis. As shown, antenna arrangement 746 includes three antennas 764. It should be appreciated, however, that the number of antennas 764 may vary widely.

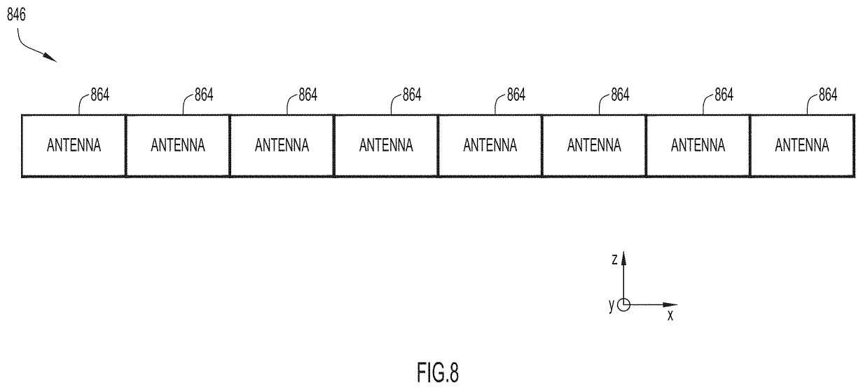

FIG. 8 is a block diagram representation of an antenna arrangement that includes horizontally arrayed antennas in accordance with an embodiment. An antenna arrangement 846 may include multiple antennas 864 that are arranged horizontally in an array. That is, multiple antennas 864 may be arrayed with respect to an x-axis. As shown, antenna arrangement 846 includes eight antennas 864, although the number of antennas 864 is not limited to being eight. In one embodiment, the dimension of antenna arrangement 846 relative to the x-axis is approximately one m in width, although it should be understood that the dimension of antenna arrangement 846 relative to the x-axis may vary. For example, the dimension of antenna arrangement 846 relative to the x-axis may be less than approximately one m.

The design of an antenna arrangement that is configured to provide a relatively high resolution in azimuth may vary widely. For example, an antenna arrangement may include multiple antenna blocks or units that each include a transmitter and a receiver, and the multiple antenna units may cooperate to act as an overall antenna arrangement for a radar system. Each antenna block may include serpentines to beam-form in azimuth, and power dividers to beam-form in elevation.

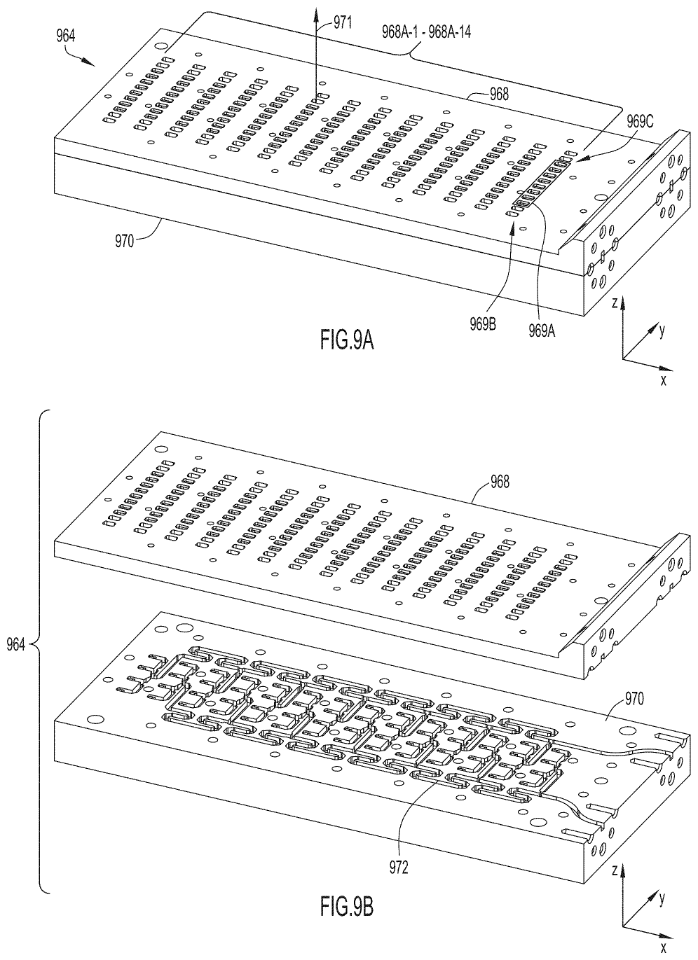

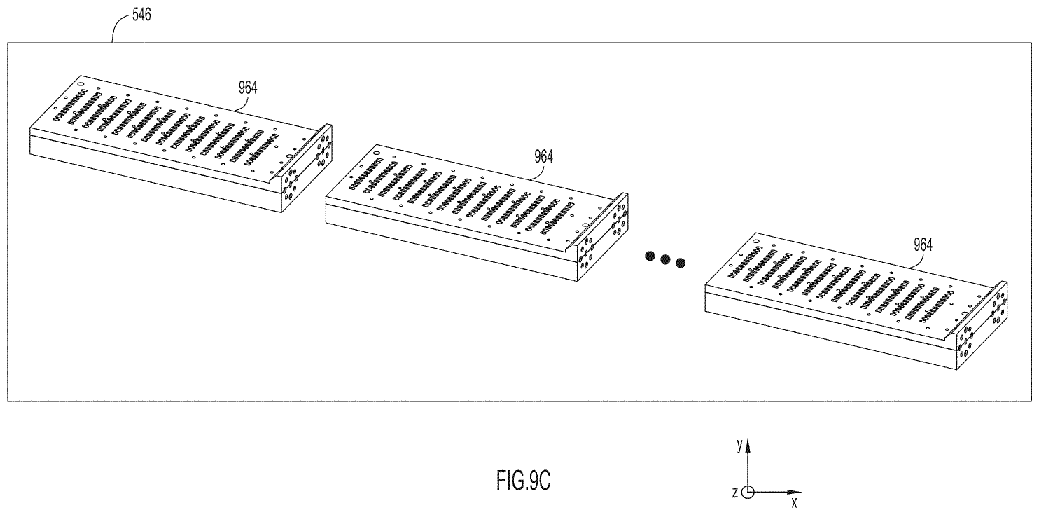

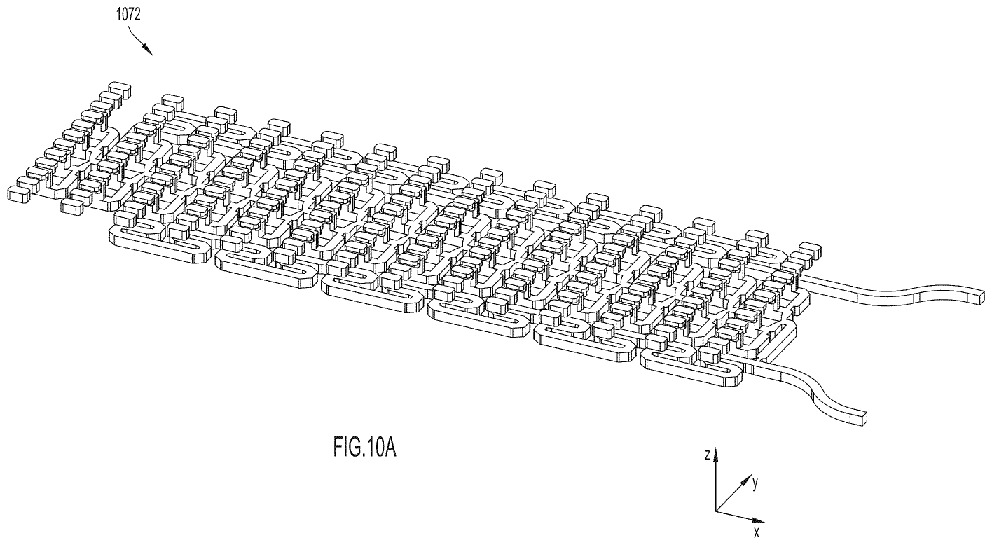

FIG. 9A is a diagrammatic representation of an antenna block in accordance with an embodiment. An antenna block 964 includes a first plate 968 and a second plate 970. Antenna block 964 is formed in a split block construction, and plates 968, 970 are generally arranged to be coupled together to function as antenna block 964. That is, plates 968, 970 are configured to be substantially fastened together to create a waveguide. Antenna block 964 generally forms a portion of an overall antenna arrangement. In one embodiment, antenna block 964 may form approximately one-eighth of an overall antenna arrangement. That is, the antenna block 964 comprises one of the transmit antennas T1-T6 of TX antenna arrangement 548a, e.g., transmit antenna T1, and one of the receive antennas R1-R8 of the RX antenna arrangement 548b, e.g., receive antenna R1, shown in FIG. 5. The transmit antenna and receive antenna contained in antenna block 964 may be interleaved with each other as described further below. Thus, to form the entire TX arrangement 548a and the entire RX arrangement 548b, there would be eight instances of antenna blocks 964, except two of the eight instances of the antenna blocks would only include a receive antenna.

Portions of plate 968 may effectively be a mirror image of portions of plate 970. For example, as shown in FIG. 9B which provides an exploded view of antenna block 964, channels or cavities 972 created in plate 970 may effectively be mirrored on a bottom side of plate 968. Plates 968, 970 may be formed from any suitable material. Suitable materials may include, but are not limited to including, aluminum, copper-plated plastic, and/or silver-plated glass. Thus, each antenna block 964 may be implemented with an airgap formed between two plates that are sandwiched together, e.g., plates 968 and 970.

When plates 968, 970 are coupled or assembled, channels 972 created in plate 970 and channels (not shown) created in plate 968 cooperate to define or to otherwise form an airgap. Plates 968, 970 may generally be formed with relatively thin layers of metal (not shown) at their walls. Plates 968, 970 may essentially provide structural support for airgaps, e.g., such that airgaps may be substantially defined. In one embodiment, plate 968 may be associated with a receiver, and plate 970 may be associated with a transmitter. The airgaps are propagate the transmit radar signal and receive radar signal.

The antenna block 964 is configured such that the emitted beam is projected upward as indicated by arrow 971 in the orientation of the antenna block shown in FIG. 9A.

The top of plate 968 includes several rows, e.g., 14 rows, 968A-1-968A-14, of apertures, some of which correspond to outputs of antenna elements of the transmit antenna and receive antenna embodied in the antenna block 964. For example, each row of apertures includes 8 output apertures 969A aligned with antenna elements of a transmit antenna or antenna elements of a receive element, since the antenna elements of the transmit and receive antennas may be interleaved, as described further below. There are two sets of two blind holes 969B and 969C on opposite ends of the 8 output apertures. The blind holes 969B and 969C do not extend into the waveguide but are only etched on the surface of the plate 968 to assist with focusing of the emitted radar beam.

FIG. 9C is a diagram showing how antenna arrangement 546 may be built from a plurality of antenna blocks 964, aligned in an array. As described above, each antenna block 964 may include waveguides for a single transmit antenna, one of the transmit antennas T1-T6 of TX antenna arrangement 548a, and one of the receive antennas R1-R8 of the RX antenna arrangement 548b shown in FIG. 5. In order to have eight receive antennas (R1-R8), there may be eight instances of antenna blocks 964, but the transmit antennas in two antenna blocks may be go unused (no connections are made to them).

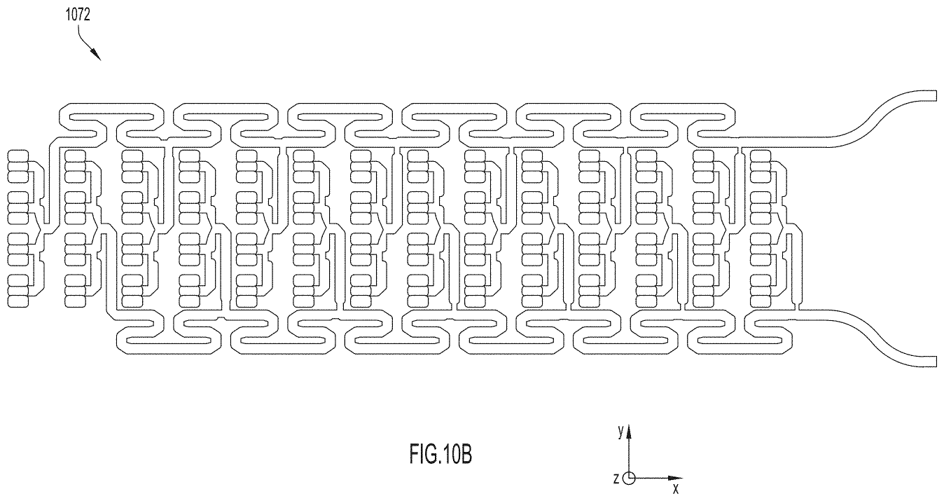

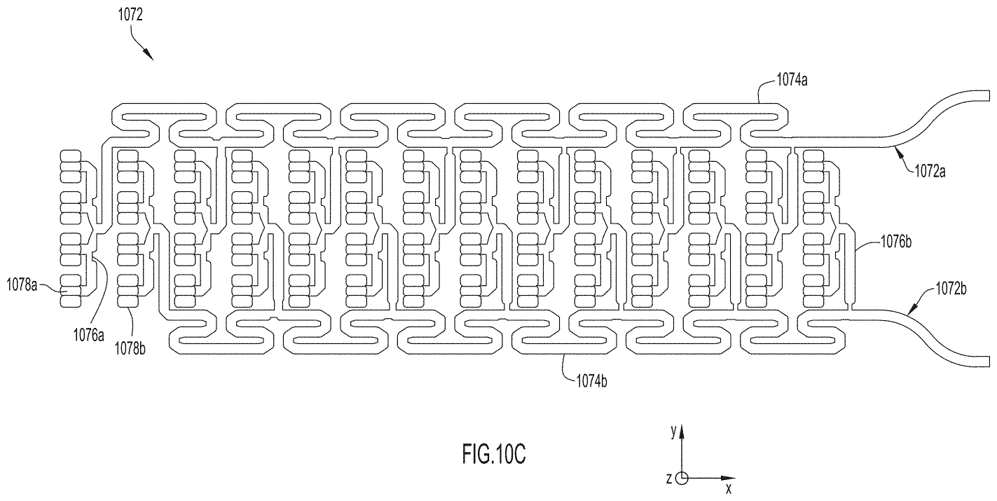

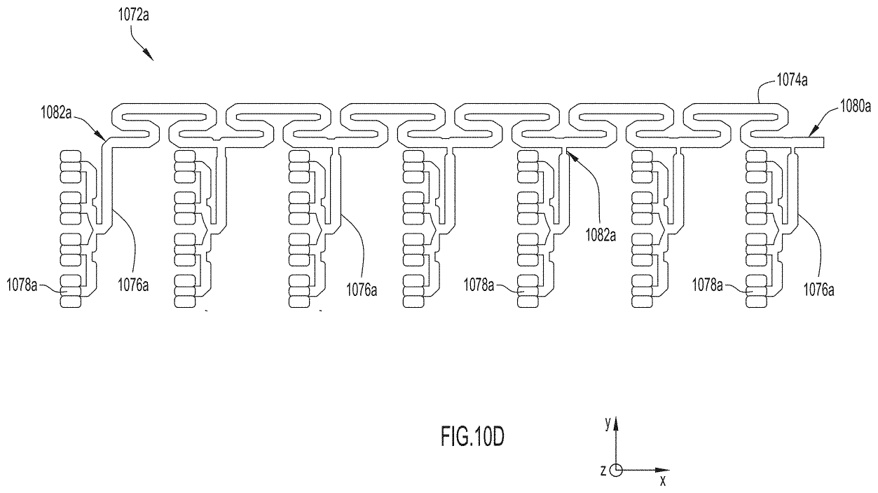

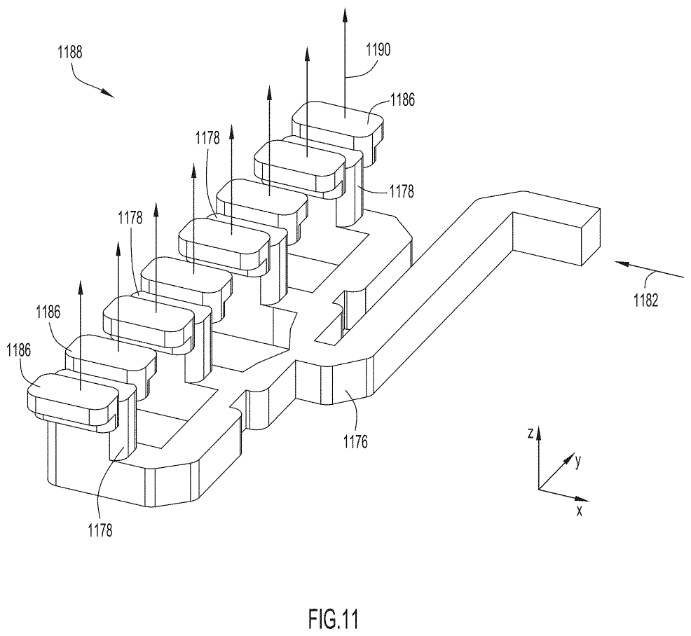

FIG. 10A is a diagrammatic representation of an airgap that may be defined within an antenna block in accordance with an embodiment. An airgap 1072 may be formed when channels in plates of an antenna block substantially align, as for example when an antenna block is assembled. It should be appreciated that airgap 1072 may include serpentine shapes, as shown, and that the configuration of airgap 1072 may vary. Again, the airgap 1072 shown in FIG. 10A is meant to be representing by the space between the metal walls shown in the diagram. The airgap 1072 defines the path for the high frequency radar signal that propagates outward from antenna elements of the transmit antenna and that detects incoming/reflected radar signals by antenna elements of the receive antenna.

As previously mentioned, an airgap such as airgap 1072 may be defined when mirror images of channels or cavities of plates are assembled to form an antenna block. FIG. 10B is a diagrammatic top view representation of an airgap, e.g., airgap 1072 of FIG. 10A, in accordance with an embodiment.

With reference to FIG. 10C, the configuration if airgap 1072 will be described in more detail in accordance with an embodiment. Airgap 1072 includes a first structure 1072a and a second structure 1072b which are effectively interleaved. In one embodiment, first structure 1072a may be associated with a transmit antenna (e.g., transmit antenna T1) and second structure 1072b may be associated with a receive antenna (e.g., antenna R1). First structure 1072a may be formed as channels in a first plate and second structure 1072b may be formed as channels in a second plate.

Each structure 1072a, 1072b includes an azimuth power divider 1074a, 1074b, respectively. Structure 1072a also includes at least one elevation power divider 1076a and at least one vertical power divider 1078a, while structure 1072b includes at least one elevation power divider 1076b and at least one vertical power divider 1078b. As shown in FIG. 10C, the transmit antenna and receive antenna, within each antenna block, are offset from each other with the plurality of elevation power dividers 1076a of the transmit antenna and the plurality of elevation power dividers 1076b of the receive antenna extending fingerlike between each other.

With reference to FIG. 10D, structure 1072a will be discussed in more detail in accordance with an embodiment. It should be appreciated that structure 1072b is substantially similar to structure 1072a and is, in one embodiment, effectively a mirror image of structure 1072a. Structure 1072a includes azimuth power divider 1074a, multiple elevation power dividers 1076a, and multiple vertical power dividers 1078a. Azimuth power divider 1074a is configured to create power and phase relations that facilitate frequency-based beam steering. Azimuth power divider 1074a obtains one input 1080a, and provides approximately seven outputs 1082a. The azimuth power divider 1074a is concerned with achieving azimuthal focus (in the horizontal or x-axis direction).

Outputs 1082a from azimuth power divider 1074a may be provided to elevation power dividers 1074a. In the described embodiment, structure 1072a includes approximately seven elevation power dividers 1076a. The elevation power dividers 1076a extend transversely off the serpentine portion that defines the azimuth power divider 1074a and each has an input that is coupled to a respective one of the plurality of outputs of the azimuth power divider 1074a. Elevation power dividers 1076a are generally configured to create power and phase relationships which enable a beam to be focused in elevation. Thus, the elevation power dividers 1076a are concerned with focusing in elevation (in the vertical or y-axis direction), and so that the coverage of the outbound radar emission covers more area in elevation. The focus of a beam in elevation may be to between approximately negative ten degrees to approximately ten degrees.

Each elevation power divider 1076a may be coupled to one vertical power dividers 1078a. As shown, structure 1072a includes approximately twenty-eight vertical power dividers 1078a. Vertical power dividers 1078a are configured to substantially connect elevation power dividers 1076a to at least one open-ended waveguide. In one embodiment, vertical power dividers 1078a are configured to substantially connect elevation power dividers 1076a to two open-ended waveguides that are substantially matched in free space.

FIG. 11 is a diagrammatic representation of an airgap 1188 (of the structure 1072a shown in FIG. 10D) for a single elevation power divider coupled to open-ended waveguides in accordance with an embodiment. A portion of airgap 1188 includes an elevation power divider 1176 that is coupled to multiple (e.g., four) vertical power dividers 1178. Each vertical power divider 1178 may be coupled to a pair of open-ended waveguides 1186.

An input 1182 of radar energy flows into elevation power divider 1176, through vertical power dividers 1178, and emerges as radar energy output 1190 that radiates from open-ended waveguides 1186 into free space. The radar energy may be between approximately seventy-six and approximately eighty-one GHz as input 1182 and as output 1190.

Waveguides 1186 may enable a beam of radar energy to be steered as a center frequency changes from approximately seventy-six and approximately eighty-one GHz. Waveguides 1186 may enable an overall antenna arrangement which includes waveguides 1186 to be relatively highly dispersive.

Referring back to FIG. 9A, the waveguides 1186 of the airgap 1188 shown in FIG. 11 are aligned with the apertures 969A of the plate 968, for respective elements of a transmit antenna and a receive antenna of the antenna block 964. The airgaps defined in the antenna block 964 are designed so that the transmit beam is emitted via multiple apertures that cover the space of approximately 3 cm and the phase at those points are consistent in order to achieve focus in the vertical dimension. Given one input and the outputs (from the 4 vertical power dividers that each of 2 waveguides) that have the same phase, the challenge is to provide an arrangement of power dividers that is sensible/practical to manufacture. A compact structure can be achieved if the power dividers of the antenna elements of a transmit antenna and receive antenna are interlaced so that they fit together without using a lot space in the horizontal direction (x-axis direction).

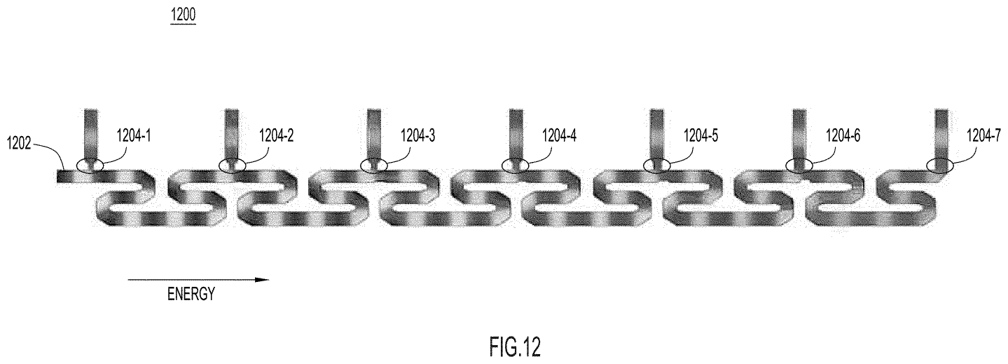

Reference is now made to FIG. 12, which shows a serpentine airgap structure 1200. The airgap structure 1200 is similar to that used for a single transmit antenna or single receive antenna in a given antenna block 964. For simplicity in describing the operation of the airgap structure 1200, only a single instance of the airgap structure 1200 is shown in FIG. 12, but it should be understood that an antenna block 964, there are two of these structures that are interleaved together, as depicted in FIGS. 10A-10C, where one airgap serves as a transmit antenna and the other airgap structure serves as a receive antenna. In the example of FIG. 12, the airgap structure 1200 is for a transmit antenna that emits a beam. However, the principles of operation of an airgap structure used for a receive antenna are the same, except a beam receive sensitivity is created for a receive antenna, rather than a transmit beam pattern.

The airgap structure 1200 has an input 1202 to which electrical magnetic energy is provided and the energy propagates from left to right. There are energy taps 1204-1, 1204-2, 1204-3, 1204-4, 1204-5, 1204-6 and 1204-7 along the length of the structure, and the width of these taps are the smallest at tap 1204-1 and become progressively largely such that tap 1204-7 is the full width of the airgap. The energy taps 1204-1-1204-7 correspond to the elevation power dividers 1076a that are spaced along the length of the azimuth power divider 1074a. The elevation power dividers 1076a feed energy to vertical power dividers, which are not shown in FIG. 12 for simplicity.

The taps 1204-1 to 1204-7 direct progressively more energy along the length of the serpentine airgap structure 1200 at these different points, where power dividing occurs. The airgap structure 1200 is designed to control the phase precisely at the different elements—to vary the phase as desired. When the frequency of the input energy is changed, this varies the phase progressively as the energy flows down the power divider segments to the right. Adjusting frequency of the incoming signal causes phase changes at the different power divided segments to steer the beam in a desired manner.

The airgap structure 1200 may be used to achieve phase variation in order to achieve a 90 degree field of view. More specifically, when used as a transmit antenna, the airgap structure 1200 emits multiple beams simultaneously and as the frequency of the input is adjusted, the beams are moved so that over the course (range) of frequency adjustment, entire field of view (e.g., 90 degree field of view) is covered by the all of the beams collectively. In other words, the airgap structure 1200 can be used to generate several beams and sweep them by some fraction of 90 degrees, rather than generating a single beam that needs to be scanned across 90 degrees. Moreover, there are a receive antenna elements of a receive antenna interlaced with transmit antenna elements of a transmit antenna (as depicted in FIGS. 10A-10C), it is possible to disambiguate the different objects in the distance that are being illuminated by the transmit antenna elements.

The terms “azimuth” and “elevation” are used herein as they are well-known terms to describe angles with respect to a ground plane. Other known terms would be “yaw” for azimuth and “pitch” for elevation, because yaw and pitch are Euler angle names. A distinction is made herein between azimuth and elevation (or yaw and pitch) because for a ground vehicle radar that detects distant objects close to the horizon, azimuth is the important axis and elevation is much less important, leading to a design that emphasizes azimuth (e.g., the reason that the radar antenna arrangement is much wider than it is high). However, it is possible to rotate the radar antenna arrangement by 90 degrees so that it is much higher that it is wide. In this case, the “elevation” direction would be the one with the better resolution and field of view. Of course, this would not be useful in a ground vehicle radar system. It is to be understood that azimuth and elevation are merely representing angles in a spherical coordinate system and not meant to imply a particular mounting orientation on a vehicle or structure.

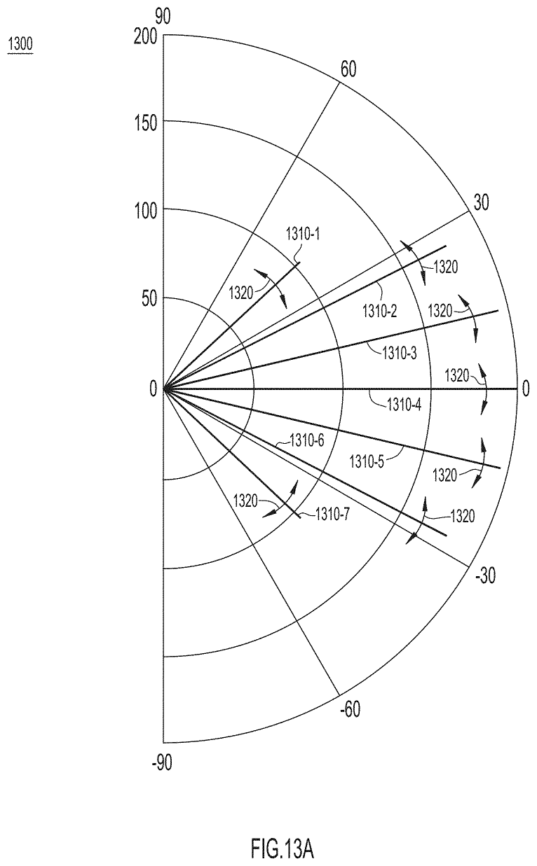

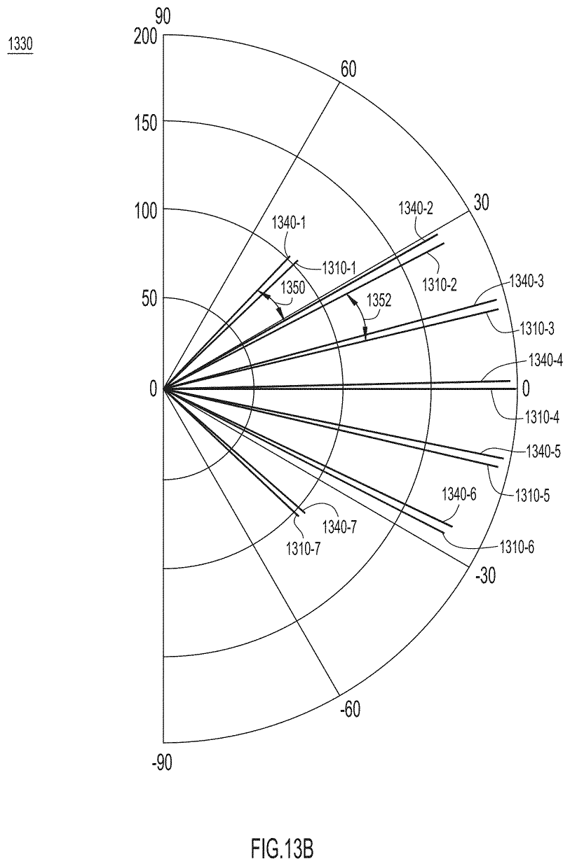

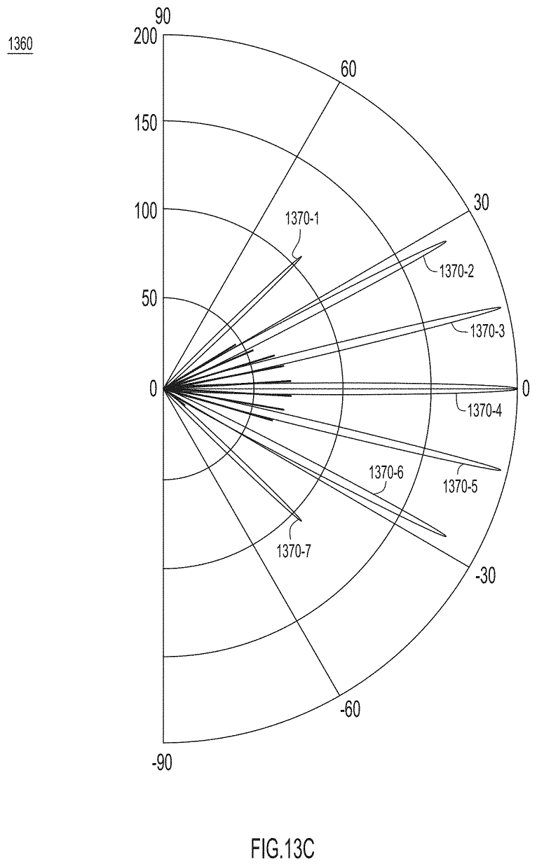

Reference is now made to FIG. 13A. FIG. 13A shows a beam pattern plot (transmit or receive) 1300 for the antenna arrangement shown 546 in FIG. 5, built from multiple antenna blocks 964 shown in FIG. 9C. These are polar plots. The axes are the azimuth angle (+/−90 degrees) and the range (0 to 200 m). The radar antenna arrangement is positioned at the origin of the plot (range=0), looking right. The range in these plots corresponds to the effective detection range of the radar at that particular azimuth, scaled to a maximum of 200 m, as an example. The radar antenna arrangement 546 emits several beams 1310-1, 1310-2, 1310-3, 1310-4, 1310-5, 1310-6 and 1310-7 simultaneously, not just one. The beams are steered by controlling the center frequency of signal supplied to the antenna arrangement, as described above in connection with FIG. 12.

There is constructive and destructive interference from the beams from all of the antenna elements so that at a distance, the resulting transmit beams are narrower, which achieves the desired azimuthal resolution. The individual antennas are not just responsible for different parts of the field of view. Rather, they create beams that add together in a constructive interference sense that results in a narrower beam.

Moreover, multiple beams are being scanned together to cover up to some field of view (e.g., 90 degrees). As shown in FIG. 13A by arrows 1320, each beam is effectively being steered over some smaller field of view (e.g., 90 degrees)/N, where N is number of beams. Thus, each beam individually does not steer very much, but together an entire (e.g., 90 degree) field of view is covered.

Receive antennas work in analogous way, but they have sensitivity to receive energy back from the environment in that orientation. The transmit beams and the receive antenna sensitivity work together to receive back what is being illuminated with a transmit beam.

Most uses of the serpentine waveguide design involve producing one beam and steering that single beam only slightly, which is acceptable for communication applications, but not for radar detection applications. As shown in FIG. 13A, several beams (e.g., seven) are steered each slightly, and thus can have the apertures (shown at reference numeral 969A in FIG. 9A) spaced only slightly apart and because it is not necessary need to more substantially steer each beam, and as a result, the serpentine waveguide shape does not need to be too wiggly. That the antenna arrangement is producing a plurality of beams means that the locations where obtaining reflected signals (in the horizontal) can be spaced that far apart and because they are spaced that far apart, the transmit and receive antennas can be interlaced together in the structure as depicted in FIGS. 9A-9C, 10A-10D, 11 and 12.

Again, by carefully controlling the spacing of the antenna elements of each transmit antenna and receive antenna and the resulting phase offsets, a constructive and destructive interference of the beams is obtained so that, at a distance, the beam contributions from the various antenna elements merge into several single beams that are narrower.

Reference is now made to FIG. 13B, which shows a plot 1330 both transmit antenna beams and receive antenna beams (sensitivity), overlaid on each other. The transmit antenna beams are shown at reference numerals 1310-1 to 1310-7, as in FIG. 13A. The receive antenna beams (sensitivity) are shown at 1340-1, 1340-2, 1340-3, 1340-4, 1340-5, 1340-6 and 1340-7. This figure shows that the receive antenna beams 1340-1 to 1340-7 are slightly offset from the transmit antenna beams 1310-1 to 1310-7, and this is desirable to facilitate proper disambiguation of reflected radiation. Moreover, the beam-to-beam (intra-beam) spacing for the receive beams 1340-1 to 1340-7, shown at reference numeral 1350, is slightly larger than the beam-to-beam (intra-beam) spacing, shown at reference numeral 1352, for the transmit beams 1310-1 to 1310-7. This intra-beam spacing difference among the receive beams and the transmit beams helps to facilitate disambiguating as to which transmit beam of the plurality of transmit beams illuminates any particular object.

Reference is now made to FIG. 13C. This figure shows an antenna beam pattern 1360 for a transmit or receive antenna formed of a single antenna element instead of a plurality of antenna elements as depicted in FIGS. 9A-9C, 10A-10D, 11 and 12. The beams resulting for such an antenna arrangement are shown at 1370-1, 1370-2 1370-3, 1370-4, 1370-5, 1370-6 and 1370-7. Using a single antenna element results in fatter/wider beams at distance. This makes azimuthal resolution worse. The more antenna elements simultaneously used for an antenna, the narrower the beams can get, as shown in FIGS. 13A and 13B.

Although only a few embodiments have been described in this disclosure, it should be understood that the disclosure may be embodied in many other specific forms without departing from the spirit or the scope of the present disclosure. By way of example, structures of an airgap defined in an antenna block have been described as each including an azimuth power divider, approximately seven elevation power dividers, and approximately twenty-eight vertical power dividers. The number of power dividers, however, may vary widely depending upon requirements and/or desired characteristics of an antenna arrangement. In other words, an airgap structure is not limited to including an azimuth power divider, approximately seven elevation power dividers, and approximately twenty-eight vertical power dividers.

The configuration of power dividers may vary. For example, while an azimuth power divider may have a substantially serpentine shape, the actual serpentine shape may vary. In addition, a power divider is not limited to having a serpentine shape.

The components of a radar system may vary. For example, a radar system may include a duplexer configured to facilitate switching between a transmitter and a receiver when an antenna arrangement is configured for used for both transmitting and receiving signals.

The arrangement of the transmit antennas and receive antennas presented herein to achieve high resolution is independent of the way those antennas are implemented. The foregoing description describes an implementation using waveguide technology, hence the metal blocks with the air gap between them. Waveguide is used because it is efficient (i.e. low loss) for large antennas. However other antenna implementations are possible, e.g. using circuit board antennas, for example. If circuit board antennas are used, the same concepts of power dividers would be implemented, but the specific geometries of those components would be different.

Increasing an azimuthal resolution may be accomplished, in one embodiment, using a radar system that is up to approximately one m wide. A range and velocity resolution may be in a range between approximately 150 m to approximately 250 m. The increased azimuthal resolution may facilitate lane placement of an autonomous vehicle at up to approximately 200 m, and may enable, for instance, unprotected turns in relatively high speed traffic to be completed. Such a lane placement at approximately 200 m may be provided with less than approximately one m of cross-range resolution. In one embodiment, the lane placement may correspond to a target azimuthal resolution bin size of approximately 0.29 degrees.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

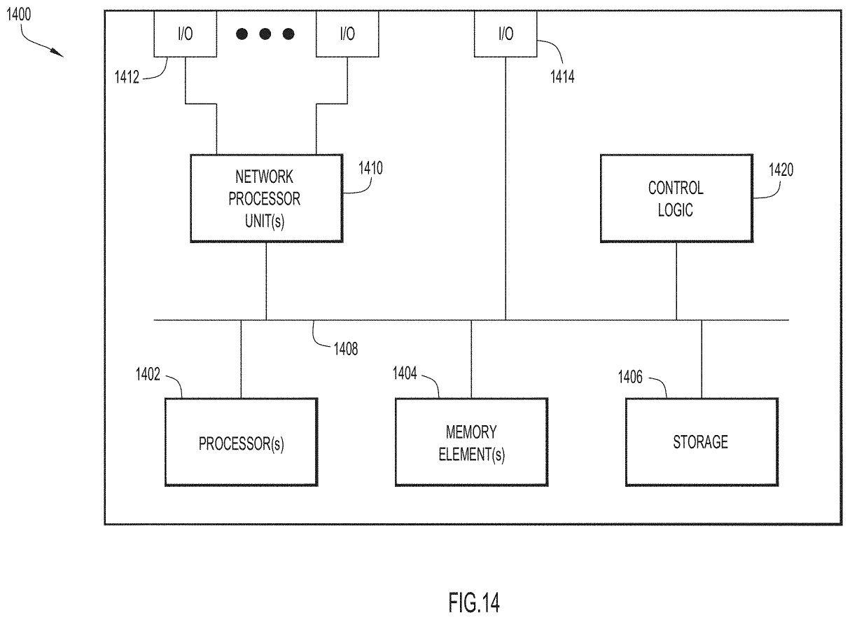

Referring to FIG. 14, FIG. 14 illustrates a hardware block diagram of a computing device 1400 that may perform functions presented herein. In various embodiments, a computing device or apparatus, such as computing device 1400 or any combination of computing devices 1400, may be configured as any entity/entities as discussed for the techniques depicted in connection with FIG. 14 in order to perform operations of the various techniques discussed herein.

In at least one embodiment, the computing device 1400 may be any apparatus that may include one or more processor(s) 1402, one or more memory element(s) 1404, storage 1406, a bus 1408, one or more network processor unit(s) 1410 interconnected with one or more network input/output (I/O) interface(s) 1412, one or more I/O interface(s) 1414, and control logic 1420. In various embodiments, instructions associated with logic for computing device 1400 can overlap in any manner and are not limited to the specific allocation of instructions and/or operations described herein.

In at least one embodiment, processor(s) 1402 is/are at least one hardware processor configured to execute various tasks, operations and/or functions for computing device 1400 as described herein according to software and/or instructions configured for computing device 1400. Processor(s) 1402 (e.g., a hardware processor) can execute any type of instructions associated with data to achieve the operations detailed herein. In one example, processor(s) 1402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1404 and/or storage 1406 is/are configured to store data, information, software, and/or instructions associated with computing device 1400, and/or logic configured for memory element(s) 1404 and/or storage 1406. For example, any logic described herein (e.g., control logic 1420) can, in various embodiments, be stored for computing device 1400 using any combination of memory element(s) 1404 and/or storage 1406. Note that in some embodiments, storage 1406 can be consolidated with memory element(s) 1404 (or vice versa), or can overlap/exist in any other suitable manner.

In at least one embodiment, bus 1408 can be configured as an interface that enables one or more elements of computing device 1400 to communicate in order to exchange information and/or data. Bus 1408 can be implemented with any architecture designed for passing control, data and/or information between processors, memory elements/storage, peripheral devices, and/or any other hardware and/or software components that may be configured for computing device 1400. In at least one embodiment, bus 1408 may be implemented as a fast kernel-hosted interconnect, potentially using shared memory between processes (e.g., logic), which can enable efficient communication paths between the processes.

In various embodiments, network processor unit(s) 1410 may enable communication between computing device 1400 and other systems, entities, etc., via network I/O interface(s) 1412 (wired and/or wireless) to facilitate operations discussed for various embodiments described herein. In various embodiments, network processor unit(s) 1410 can be configured as a combination of hardware and/or software, such as one or more Ethernet driver(s) and/or controller(s) or interface cards, wireless receivers/transmitters/transceivers, baseband processor(s)/modem(s), and/or other similar network interface driver(s) and/or controller(s) now known or hereafter developed to enable communications between computing device 1400 and other systems, entities, etc. to facilitate operations for various embodiments described herein. In various embodiments, network I/O interface(s) 1412 can be configured as one or more Ethernet port(s), any other I/O port(s), and/or antenna(s)/antenna array(s) now known or hereafter developed. Thus, the network processor unit(s) 1410 and/or network I/O interface(s) 1412 may include suitable interfaces for receiving, transmitting, and/or otherwise communicating data and/or information in a network environment.

I/O interface(s) 1414 allow for input and output of data and/or information with other entities that may be connected to computer device 1400. For example, I/O interface(s) 1414 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1420 can include instructions that, when executed, cause processor(s) 1402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1420) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1404 and/or storage 1406 can store data, software, code, instructions (e.g., processor instructions), logic, parameters, combinations thereof, and/or the like used for operations described herein. This includes memory element(s) 1404 and/or storage 1406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

To the extent that embodiments presented herein relate to the storage of data, the embodiments may employ any number of any conventional or other databases, data stores or storage structures (e.g., files, databases, data structures, data or other repositories, etc.) to store information.

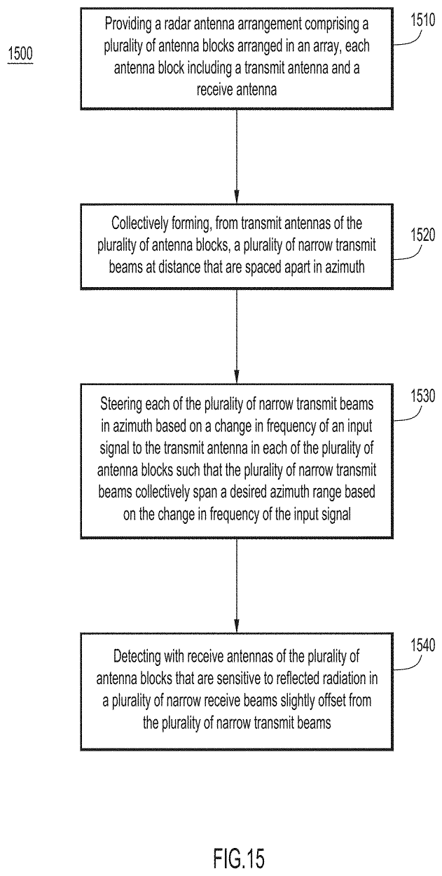

Reference is now made to FIG. 15, which illustrates a flow chart for a method 1500 according to an example embodiment. The method 1500 is useful for operating a radar system employing the various radar antenna arrangement structures described herein. At 1510, the method 1500 includes providing a radar antenna arrangement comprising a plurality of antenna blocks arranged in an array. Each antenna block includes a transmit antenna and a receive antenna. At 1520, the method 1500 involves collectively forming, from transmit antennas of the plurality of antenna blocks, a plurality of narrow transmit beams at distance that are spaced apart in azimuth. At 1530, the method 1500 involves steering each of the plurality of narrow transmit beams in azimuth based on a change in frequency of an input signal to the transmit antenna in each of the plurality of antenna blocks such that the plurality of narrow transmit beams collectively span a desired azimuth range based on the change in frequency of the input signal. At 1540, (and contemporaneously with operation 1530), the method 1500 includes detecting with receive antennas of the plurality of antenna blocks that are sensitive to reflected radiation in a plurality of narrow receive beams slightly offset from the plurality of narrow transmit beams. As described above, the plurality of narrow receive beams may have a slightly larger beam-to-beam spacing than a beam-to-beam spacing of the plurality of narrow transmit beams to facilitate disambiguating as to which transmit beam of the plurality of narrow transmit beams illuminates any particular object.

In some aspects, the techniques described herein relate to a radar antenna arrangement including: a plurality of antenna blocks arranged in an array, each antenna block including a transmit antenna and a receive antenna, the transmit antenna and the receive antenna each including a waveguide including: a serpentine portion defining an azimuth power divider having an input at a first end and a plurality of outputs at spaced apart locations along a length of the serpentine portion between the first end and a second end to create power and phase relationships to achieve frequency-based beam steering in azimuth; a plurality of elevation power dividers extending transversely off the serpentine portion and having an input that is coupled to a respective one of the plurality of outputs of the azimuth power divider, each of the plurality of elevation power dividers having a plurality of outputs and being configured to create power and phase relationships to achieve beam focus in elevation; and a plurality of vertical power dividers each having an input that is coupled to a respective one of the plurality of outputs of the plurality of elevation power dividers; wherein the transmit antenna and the receive antenna of a given antenna block of the plurality of antenna blocks are arranged such that the azimuth power divider of the transmit antenna is offset in elevation from the azimuth power divider of the receive antenna, and respective ones of the plurality of elevation power dividers of the transmit antenna extend toward the azimuth power divider of the receive antenna and are interleaved with respective ones of the plurality of elevation power dividers of the receive antenna which extend toward the azimuth power divider of the transmit antenna.

In some aspects, within each antenna block, the transmit antenna and the receive antenna are offset from each other with the plurality of elevation power dividers of the transmit antenna and the plurality of elevation power dividers of the receive antenna extending fingerlike between each other.

In some aspects, transmit antennas of the plurality of antenna blocks in the array are configured to, collectively, form a plurality of narrow transmit beams at distance that are spaced apart in azimuth, and each of the plurality of narrow transmit beams is steered in azimuth based on a change in frequency of an input signal to the transmit antenna in each of the plurality of antenna blocks such that the plurality of narrow transmit beams collectively span a desired azimuth range based on the change in frequency of the input signal, and receive antennas of the plurality of antenna blocks are configured to be sensitive to reflected radiation in a plurality of narrow receive beams slightly offset from the plurality of narrow transmit beams.

In some aspects, the techniques described herein relate to a radar antenna arrangement, wherein the plurality of narrow receive beams have a slightly larger beam-to-beam spacing than a beam-to-beam spacing of the plurality of narrow transmit beams to facilitate disambiguating as to which transmit beam of the plurality of narrow transmit beams illuminates any particular object.

In some aspects, the techniques described herein relate to a radar antenna arrangement, wherein the plurality of vertical power dividers of the transmit antenna are coupled to a pair of open-ended waveguides through which energy radiates from the transmit antenna and the plurality of vertical power dividers of the receive antenna are coupled to a pair of open-ended waveguides via which energy is received.

In some aspects, the techniques described herein relate to a radar antenna arrangement, wherein each antenna block of the plurality of antenna blocks is implemented with an airgap formed between two plates that are sandwiched together.

In some aspects, the techniques described herein relate to a system including the radar antenna arrangement, and further including: a first radar sensor configured to be coupled to a first subset of transmit antennas across the plurality of antenna blocks and to a first subset of receive antennas across the plurality of antenna blocks, the first radar sensor providing a transmit signal to a respective one of the first subset of transmit antennas and processing a receive signal obtained from a respective one of the first subset of receive antennas; and a second radar sensor configured to be coupled to a second subset of transmit antennas across the plurality of antenna blocks and to a first subset of receive antennas across the plurality of antenna blocks, the second radar sensor providing a transmit signal to a respective one of the second subset of transmit antennas and processing a receive signal obtained from a respective one of the second subset of receive antennas.

In some aspects, the techniques described herein relate to a radar system, further including a local oscillator coupled to the first radar sensor and to the second radar sensor to achieve coherent operation of the first radar sensor and the second radar sensor.

In some aspects, the techniques described herein relate to a radar system, wherein the first radar sensor and the second radar sensor are each frequency modulated continuous wave (FMCW) radar sensors.

In some aspects, the techniques described herein relate to a radar system including: an antenna arrangement including a plurality of antenna blocks arranged in an array, each antenna block including a transmit antenna and a receive antenna, wherein transmit antennas of the plurality of antenna blocks in the array are configured to, collectively, form a plurality of narrow transmit beams at distance that are spaced apart in azimuth, and each of the plurality of narrow transmit beams is steered in azimuth based on a change in frequency of an input signal to the transmit antenna in each of the plurality of antenna blocks such that the plurality of narrow transmit beams collectively span a desired azimuth range based on the change in frequency of the input signal, and receive antennas of the plurality of antenna blocks are configured to be sensitive to reflected radiation in a plurality of narrow receive beams slightly offset from the plurality of narrow transmit beams. a first radar sensor configured to be coupled to a first subset of transmit antennas across the plurality of antenna blocks and to a first subset of receive antennas across the plurality of antenna blocks, the first radar sensor providing a transmit signal to a respective one of the first subset of transmit antennas and processing a receive signal obtained from a respective one of the first subset of receive antennas; and a second radar sensor configured to be coupled to a second subset of transmit antennas across the plurality of antenna blocks and to a first subset of receive antennas across the plurality of antenna blocks, the second radar sensor providing a transmit signal to a respective one of the second subset of transmit antennas and processing a receive signal obtained from a respective one of the second subset of receive antennas.

In some aspects, the techniques described herein relate to a radar system, further including a local oscillator coupled to the first radar sensor and to the second radar sensor to achieve coherent operation of the first radar sensor and the second radar sensor.

In some aspects, the techniques described herein relate to a radar system, wherein the first radar sensor and the second radar sensor are each frequency modulated continuous wave (FMCW) radar sensors.

In some aspects, the techniques described herein relate to a radar system, wherein the transmit antenna and the receive antenna each include a waveguide including: a serpentine portion defining an azimuth power divider having an input at a first end and a plurality of outputs at spaced apart locations along a length of the serpentine portion between the first end and a second end to create power and phase relationships to achieve frequency-based beam steering in azimuth; a plurality of elevation power dividers extending transversely off the serpentine portion and having an input that is coupled to a respective one of the plurality of outputs of the azimuth power divider, each of the plurality of elevation power dividers having a plurality of outputs and being configured to create power and phase relationships to achieve beam focus in elevation; and a plurality of vertical power dividers each having an input that is coupled to a respective one of the plurality of outputs of the plurality of elevation power dividers; wherein the transmit antenna and the receive antenna of a given antenna block of the plurality of antenna blocks are arranged such that the azimuth power divider of the transmit antenna is offset in elevation from the azimuth power divider of the receive antenna, and respective ones of the plurality of elevation power dividers of the transmit antenna extend toward the azimuth power divider of the receive antenna and are interleaved with respective ones of the plurality of elevation power dividers of the receive antenna which extend toward the azimuth power divider of the transmit antenna;

In some aspects, the techniques described herein relate to a radar system, wherein within each antenna block, the transmit antenna and the receive antenna are offset from each other with the plurality of elevation power dividers of the transmit antenna and the plurality of elevation power dividers of the receive antenna extending fingerlike between each other.

In some aspects, the techniques described herein relate to a radar system, wherein the plurality of narrow receive beams have a slightly larger beam-to-beam spacing than a beam-to-beam spacing of the plurality of narrow transmit beams to facilitate disambiguating as to which transmit beam of the plurality of narrow transmit beams illuminates any particular object.

In some aspects, the techniques described herein relate to a radar system, wherein the plurality of vertical power dividers of the transmit antenna are coupled to a pair of open-ended waveguides through which energy radiates from the transmit antenna and the plurality of vertical power dividers of the receive antenna are coupled to a pair of open-ended waveguides via which energy is received.

In some aspects, the techniques described herein relate to a method including: providing a radar antenna arrangement including a plurality of antenna blocks arranged in an array, each antenna block including a transmit antenna and a receive antenna; collectively forming, from transmit antennas of the plurality of antenna blocks, a plurality of narrow transmit beams at distance that are spaced apart in azimuth; steering each of the plurality of narrow transmit beams in azimuth based on a change in frequency of an input signal to the transmit antenna in each of the plurality of antenna blocks such that the plurality of narrow transmit beams collectively span a desired azimuth range based on the change in frequency of the input signal; and detecting with receive antennas of the plurality of antenna blocks that are sensitive to reflected radiation in a plurality of narrow receive beams slightly offset from the plurality of narrow transmit beams.

In some aspects, the techniques described herein relate to a method, wherein the plurality of narrow receive beams have a slightly larger beam-to-beam spacing than a beam-to-beam spacing of the plurality of narrow transmit beams to facilitate disambiguating as to which transmit beam of the plurality of narrow transmit beams illuminates any particular object.

In some aspects, the techniques described herein relate to a method, wherein the transmit antenna and the receive antenna each including a waveguide including: a serpentine portion defining an azimuth power divider having an input at a first end and a plurality of outputs at spaced apart locations along a length of the serpentine portion between the first end and a second end to create power and phase relationships to achieve frequency-based beam steering in azimuth; a plurality of elevation power dividers extending transversely off the serpentine portion and having an input that is coupled to a respective one of the plurality of outputs of the azimuth power divider, each of the plurality of elevation power dividers having a plurality of outputs and being configured to create power and phase relationships to achieve beam focus in elevation; and a plurality of vertical power dividers each having an input that is coupled to a respective one of the plurality of outputs of the plurality of elevation power dividers

In some aspects, the techniques described herein relate to a method, wherein the transmit antenna and the receive antenna of a given antenna block of the plurality of antenna blocks are arranged such that the azimuth power divider of the transmit antenna is offset in elevation from the azimuth power divider of the receive antenna, and respective ones of the plurality of elevation power dividers of the transmit antenna extend toward the azimuth power divider of the receive antenna and are interleaved with respective ones of the plurality of elevation power dividers of the receive antenna which extend toward the azimuth power divider of the transmit antenna.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. A radar antenna arrangement comprising:
a plurality of antenna blocks arranged in an array, each antenna block including a transmit antenna and a receive antenna, the transmit antenna and the receive antenna each comprising a waveguide including:
a serpentine portion defining an azimuth power divider having an input at a first end and a plurality of outputs at spaced apart locations along a length of the serpentine portion between the first end and a second end to create power and phase relationships to achieve frequency-based beam steering in azimuth;
a plurality of elevation power dividers extending transversely off the serpentine portion and having an input that is coupled to a respective one of the plurality of outputs of the azimuth power divider, each of the plurality of elevation power dividers having a plurality of outputs and being configured to create power and phase relationships to achieve beam focus in elevation; and
a plurality of vertical power dividers each having an input that is coupled to a respective one of the plurality of outputs of the plurality of elevation power dividers;
wherein the transmit antenna and the receive antenna of a given antenna block of the plurality of antenna blocks are arranged such that the azimuth power divider of the transmit antenna is offset in elevation from the azimuth power divider of the receive antenna, and respective ones of the plurality of elevation power dividers of the transmit antenna extend toward the azimuth power divider of the receive antenna and are interleaved with respective ones of the plurality of elevation power dividers of the receive antenna which extend toward the azimuth power divider of the transmit antenna.

2. The radar antenna arrangement of claim 1, wherein within each antenna block, the transmit antenna and the receive antenna are offset from each other with the plurality of elevation power dividers of the transmit antenna and the plurality of elevation power dividers of the receive antenna extending fingerlike between each other.

3. The radar antenna arrangement of claim 2, wherein transmit antennas of the plurality of antenna blocks in the array are configured to, collectively, form a plurality of narrow transmit beams at distance that are spaced apart in azimuth, and each of the plurality of narrow transmit beams is steered in azimuth based on a change in frequency of an input signal to the transmit antenna in each of the plurality of antenna blocks such that the plurality of narrow transmit beams collectively span a desired azimuth range based on the change in frequency of the input signal, and receive antennas of the plurality of antenna blocks are configured to be sensitive to reflected radiation in a plurality of narrow receive beams slightly offset from the plurality of narrow transmit beams.

4. The radar antenna arrangement of claim 3, wherein the plurality of narrow receive beams have a slightly larger beam-to-beam spacing than a beam-to-beam spacing of the plurality of narrow transmit beams to facilitate disambiguating as to which transmit beam of the plurality of narrow transmit beams illuminates any particular object.

5. The radar antenna arrangement of claim 1, wherein the plurality of vertical power dividers of the transmit antenna are coupled to a pair of open-ended waveguides through which energy radiates from the transmit antenna and the plurality of vertical power dividers of the receive antenna are coupled to a pair of open-ended waveguides via which energy is received.

6. The radar antenna arrangement of claim 1, wherein each antenna block of the plurality of antenna blocks is implemented with an airgap formed between two plates that are sandwiched together.

7. A radar system comprising the radar antenna arrangement of claim 1, and further comprising:
a first radar sensor configured to be coupled to a first subset of transmit antennas across the plurality of antenna blocks and to a first subset of receive antennas across the plurality of antenna blocks, the first radar sensor providing a transmit signal to a respective one of the first subset of transmit antennas and processing a receive signal obtained from a respective one of the first subset of receive antennas; and
a second radar sensor configured to be coupled to a second subset of transmit antennas across the plurality of antenna blocks and to a first subset of receive antennas across the plurality of antenna blocks, the second radar sensor providing a transmit signal to a respective one of the second subset of transmit antennas and processing a receive signal obtained from a respective one of the second subset of receive antennas.

8. The radar system of claim 7, further comprising a local oscillator coupled to the first radar sensor and to the second radar sensor to achieve coherent operation of the first radar sensor and the second radar sensor.

9. The radar system of claim 7, wherein the first radar sensor and the second radar sensor are each frequency modulated continuous wave (FMCW) radar sensors.

10. A radar system comprising:
an antenna arrangement comprising a plurality of antenna blocks arranged in an array, each antenna block including a transmit antenna and a receive antenna, wherein transmit antennas of the plurality of antenna blocks in the array are configured to, collectively, form a plurality of narrow transmit beams at distance that are spaced apart in azimuth, and each of the plurality of narrow transmit beams is steered in azimuth based on a change in frequency of an input signal to the transmit antenna in each of the plurality of antenna blocks such that the plurality of narrow transmit beams collectively span a desired azimuth range based on the change in frequency of the input signal, and receive antennas of the plurality of antenna blocks are configured to be sensitive to reflected radiation in a plurality of narrow receive beams slightly offset from the plurality of narrow transmit beams;
a first radar sensor configured to be coupled to a first subset of transmit antennas across the plurality of antenna blocks and to a first subset of receive antennas across the plurality of antenna blocks, the first radar sensor providing a transmit signal to a respective one of the first subset of transmit antennas and processing a receive signal obtained from a respective one of the first subset of receive antennas; and
a second radar sensor configured to be coupled to a second subset of transmit antennas across the plurality of antenna blocks and to a first subset of receive antennas across the plurality of antenna blocks, the second radar sensor providing a transmit signal to a respective one of the second subset of transmit antennas and processing a receive signal obtained from a respective one of the second subset of receive antennas.

11. The radar system of claim 10, further comprising a local oscillator coupled to the first radar sensor and to the second radar sensor to achieve coherent operation of the first radar sensor and the second radar sensor.

12. The radar system of claim 11, wherein the first radar sensor and the second radar sensor are each frequency modulated continuous wave (FMCW) radar sensors.

13. The radar system of claim 10, wherein the transmit antenna and the receive antenna each comprise a waveguide including:
a serpentine portion defining an azimuth power divider having an input at a first end and a plurality of outputs at spaced apart locations along a length of the serpentine portion between the first end and a second end to create power and phase relationships to achieve frequency-based beam steering in azimuth;
a plurality of elevation power dividers extending transversely off the serpentine portion and having an input that is coupled to a respective one of the plurality of outputs of the azimuth power divider, each of the plurality of elevation power dividers having a plurality of outputs and being configured to create power and phase relationships to achieve beam focus in elevation; and
a plurality of vertical power dividers each having an input that is coupled to a respective one of the plurality of outputs of the plurality of elevation power dividers;
wherein the transmit antenna and the receive antenna of a given antenna block of the plurality of antenna blocks are arranged such that the azimuth power divider of the transmit antenna is offset in elevation from the azimuth power divider of the receive antenna, and respective ones of the plurality of elevation power dividers of the transmit antenna extend toward the azimuth power divider of the receive antenna and are interleaved with respective ones of the plurality of elevation power dividers of the receive antenna which extend toward the azimuth power divider of the transmit antenna.

14. The radar system of claim 13, wherein within each antenna block, the transmit antenna and the receive antenna are offset from each other with the plurality of elevation power dividers of the transmit antenna and the plurality of elevation power dividers of the receive antenna extending fingerlike between each other.

15. The radar system of claim 13, wherein the plurality of narrow receive beams have a slightly larger beam-to-beam spacing than a beam-to-beam spacing of the plurality of narrow transmit beams to facilitate disambiguating as to which transmit beam of the plurality of narrow transmit beams illuminates any particular object.

16. The radar system of claim 13, wherein the plurality of vertical power dividers of the transmit antenna are coupled to a pair of open-ended waveguides through which energy radiates from the transmit antenna and the plurality of vertical power dividers of the receive antenna are coupled to a pair of open-ended waveguides via which energy is received.

17. A method comprising:
providing a radar antenna arrangement comprising a plurality of antenna blocks arranged in an array, each antenna block including a transmit antenna and a receive antenna;
collectively forming, from transmit antennas of the plurality of antenna blocks, a plurality of narrow transmit beams at distance that are spaced apart in azimuth;
steering each of the plurality of narrow transmit beams in azimuth based on a change in frequency of an input signal to the transmit antenna in each of the plurality of antenna blocks such that the plurality of narrow transmit beams collectively span a desired azimuth range based on the change in frequency of the input signal; and
detecting with receive antennas of the plurality of antenna blocks that are sensitive to reflected radiation in a plurality of narrow receive beams slightly offset from the plurality of narrow transmit beams.

18. The method of claim 17, wherein the plurality of narrow receive beams have a slightly larger beam-to-beam spacing than a beam-to-beam spacing of the plurality of narrow transmit beams to facilitate disambiguating as to which transmit beam of the plurality of narrow transmit beams illuminates any particular object.

19. The method of claim 17, wherein the transmit antenna and the receive antenna each comprising a waveguide including:
a serpentine portion defining an azimuth power divider having an input at a first end and a plurality of outputs at spaced apart locations along a length of the serpentine portion between the first end and a second end to create power and phase relationships to achieve frequency-based beam steering in azimuth;
a plurality of elevation power dividers extending transversely off the serpentine portion and having an input that is coupled to a respective one of the plurality of outputs of the azimuth power divider, each of the plurality of elevation power dividers having a plurality of outputs and being configured to create power and phase relationships to achieve beam focus in elevation; and
a plurality of vertical power dividers each having an input that is coupled to a respective one of the plurality of outputs of the plurality of elevation power dividers.

20. The method of claim 19, wherein the transmit antenna and the receive antenna of a given antenna block of the plurality of antenna blocks are arranged such that the azimuth power divider of the transmit antenna is offset in elevation from the azimuth power divider of the receive antenna, and respective ones of the plurality of elevation power dividers of the transmit antenna extend toward the azimuth power divider of the receive antenna and are interleaved with respective ones of the plurality of elevation power dividers of the receive antenna which extend toward the azimuth power divider of the transmit antenna.
